(19) United States
(12) Patent Application Publication
(10) Pub. No.: US 2009/0147265 A1
(43) Pub. Date: Jun. 11, 2009

(54) DETECTION SYSTEM FOR DETECTING TRANSLATIONS OF A BODY

(75) Inventors: Renatus Gerardus Klaver, Eindhoven (NL); Johan Cornelis Compter, Eindhoven (NL); Piet Van Der Meer, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/719,563

(22) PCT Filed: Nov. 17, 2005
(86) PCT No.: PCT/IB05/53800

§ 371 Date: May 17, 2007

(30) Foreign Application Priority Data
Nov. 22, 2004 (EP) 04105955.1

(51) Int. Cl. G01B 9/02

(52) U.S. Cl. 356/488; 356/499

(57) ABSTRACT

The invention relates to a system (1) for detecting a translation (T) of a body (2) with a diffraction pattern (3) applied to said body. The system comprises means (4) for providing an incident light beam (I) to said diffraction pattern and to obtain a diffracted light beam (D) from said diffraction pattern; means (4) for measuring a phase difference by interference between said incident light beam and said diffracted beam an means (4) for detecting said translation on the basis of said measured phase difference. The invention further relates to a method for detecting a translation of a body (2); a redirection arrangement 6 and a frequency multiplexing system.

The invention relates to a system for detecting a translation of a body. More specifically, the invention relates to a system for detecting a translation of a body with a diffraction pattern, in particular parallel to the normal of a plane with said diffraction pattern by providing incident light beams to said diffraction pattern. The invention further relates to a method for detecting a translation of a body with a diffraction pattern, a redirection arrangement and a frequency multiplexing system.

Accurate measurement of the position or position variations of moving bodies is required in various technological applications. As an example, lithographic projection tools and wafer inspection tools applied in the semiconductor industry require accurate information on position variations of semiconductor wafers. Another field of use involves the printed circuit board (PCB) industry, wherein information on the position of the PCB is required in mounting components on a PCB, printing patterns on a PCB or inspection of PCB's.

Typically, translations of bodies are measured optically by providing incident light beams to said bodies. As an example, U.S. Pat. No. 4,710,026 discloses an apparatus including a means for providing a predetermined frequency difference between two light beams and generating an optical beat with respect to interference between first and second diffracted light beams from a diffraction grating formed on a substrate. The apparatus further has means for detecting a phase difference between the optical beat and a reference signal having a frequency corresponding to the frequency difference between the two light beams and detects a position of the substrate based upon the phase difference in accordance with an optical heterodyne interference method.

The prior art position detection apparatus is suitable for measuring translations of the substrate in the plane of the diffraction pattern. However, the detection apparatus is not able to measure out-of-plane translations of the substrate.

It is an object of the present invention to provide a system for allowing detection of out-of-plane translations of a body in an optical system.

This object is accomplished by providing a system for detecting a translation of a body with a diffraction pattern applied to said body, said system comprising:

means for providing an incident light beam to said diffraction pattern and to obtain a diffracted light beam from said diffraction pattern;

means for measuring a phase difference by interference between said incident light beam and said diffracted beam;

means for detecting said translation on the basis of said measured phase difference.

Instead of measuring the phase difference between diffracted beams, the phase of a diffracted beam is measured individually by interference of the diffracted beam with an incident light beam. The prior art concept assumes, in line with the classical explanation of the well-known laser-doppler effect, the existence of an interference pattern at the diffraction pattern, whereas, according to the invention, interference is assumed at the means for measuring the phase difference. Consequently, the measured phase difference contains information on the out-of-plane translation of the grating, and thus, of the body.

It should be appreciated that the diffracted light beam is not necessarily the result of the incident light beam. It should further be appreciated that every order of the diffracted light beam with sufficient optical power can be used for detecting the translation according to the invention. Moreover, it is noted that the light beam is not necessarily incident to the diffraction grating, as defined in claim 20, as long as the light beam is coherent with a diffracted beam from the diffraction grating.

The embodiment of the invention as defined in claim 3 provides the advantage that all translations, i.e. both in-plane and out-of-plane, can be detected. In a preferable embodiment, phase differences are determined between the first incident beam and the resulting first diffracted beam, the second incident beam and the resulting second diffracted beam and the third incident beam and the resulting third diffracted beam.

The embodiment of the invention as defined in claim 4 has the advantage that, apart from the translations, also rotations of the body can be determined. If the body rotates, this also influences the phases of the diffracted beams for measuring translation of the body. Therefore, for a body with a significant rotating motion component, the rotation should be determined to calculate the translation of the body. Accordingly, a system is obtained for determining movements for all degrees of freedom.

The embodiment of the invention as defined in claim 5 has the advantage that the redirecting means provide for a small or negligible, preferably zero, angle between an incident beam and a diffracted beam. Accordingly, the measured interference between the incident beam and diffracted beam consists of a single spot with a varying intensity. This enables the use of a relatively simple detector for measuring the interference. Further, by enabling beams to diffract several times at the diffraction pattern, translations of the body can be determined with a higher accuracy. A particularly advantageous embodiment of the first redirection means is defined in claim 6.

The embodiment of the invention as defined in claim 7 has the advantage that the use of the reference beam for both the measurement of the phase of the incident beam and the phase of the diffracted beam increases the accuracy of the measured phase difference between said beams.

The embodiment of the invention as defined in claims 8 and 9 has the advantage that diffracted light beams from particular incident beams do not detrimentally influence the measurement of the phase difference, i.e. cross talk between diffracted beams is eliminated or reduced. This embodiment may apply separate lasers for each incident light beam, wherein these lasers are incoherent or have an appropriately large frequency difference. Alternatively, a single laser of which the light beam is split in parts, can be used. In particular, at least one of those parts may be used for the reference beam in a heterodyne system.

The embodiment of the invention as defined in claims 10-13 has the advantage of reduced complexity, and accordingly reduced costs, as compared to the system of claims 8 and 9. The stabilized laser for a reference beam and the modulation scheme with the wavelength trigger account for the inherent instability of a semiconductor laser and the preferably high modulation frequencies. Other types of lasers, e.g. a gas laser, may be used as well, as long as such lasers are sensitive for light reflected towards said lasers. The high frequency of the modulation it to obtain an adequate number of samples for a translation of the diffraction pattern. This homodyne embodiment applying laser self mixing is suitable for applications requiring less accuracy in detecting translations.

It should be appreciated that the embodiments described above, or aspects thereof, may be combined.

The invention also relates to a method for detecting a translation of a body with a diffraction pattern applied to said body, comprising the steps of:

providing an incident light beam to said diffraction pattern;

obtaining a diffracted light beam from said diffraction pattern;

measuring a phase difference by interfering said incident light beam and said diffracted beam;

detecting said translation on the basis of said measured phase difference.

The method according to the invention enable the measured phase difference to contain information on the out-of-plane translation of the grating, and thus, of the body. In the embodiment of the invention as defined in claims 15 and 16, the method provides information of all translations, respectively, all rotations of the body.

Finally the invention also relates to components of the above described system or applied for the method.

In particular, the invention relates to a redirection arrangement for returning a light beam incident on said arrangement substantially along the same optical path, said arrangement comprising a cube corner, a polarizing beam splitter, a half wavelength plate and a prism. When applied in the system for determining translations of a body, this arrangement has the advantage that the redirecting means provide for a small or negligible, preferably zero, angle between an incident beam and a diffracted beam. However, the redirection arrangement can be more generally applied in case of incident light beams that should be redirected along the optical path of the incident light beam.

Moreover, the invention relates to a frequency multiplexing system arranged to provide light beams to a body with a diffraction pattern in a system for detecting translations of said body, wherein said frequency multiplexing system comprises a single laser source to provide a laser beam of a predetermined frequency and means for splitting said laser beam into a plurality of parts and shifting the frequency of one or more of said parts to obtain different frequencies for said incident light beams, wherein said system is arranged to use one of said parts as a reference beam in combination with each of said incident beams for said system for detecting a translation of said body.

The invention will be further illustrated with reference to the attached drawings, which schematically show a preferred embodiment according to the invention. It will be understood that the invention is not in any way restricted to this specific and preferred embodiment.

In the drawings:

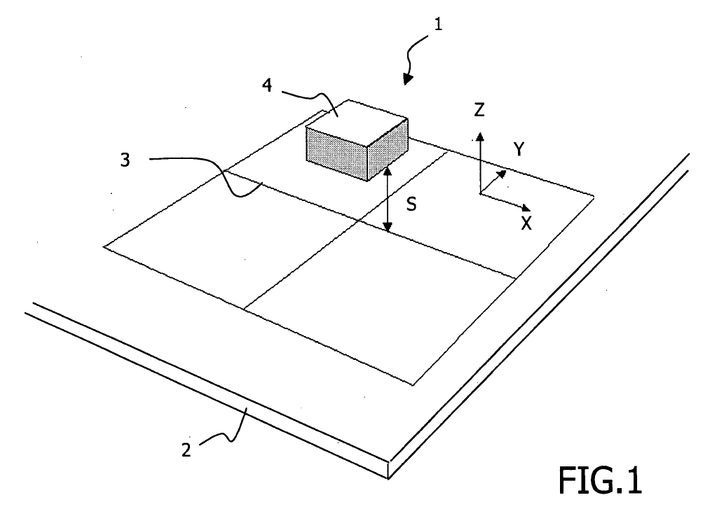

FIG. 1 illustrates a body with a diffraction pattern and a measurement head according to an embodiment of the invention;

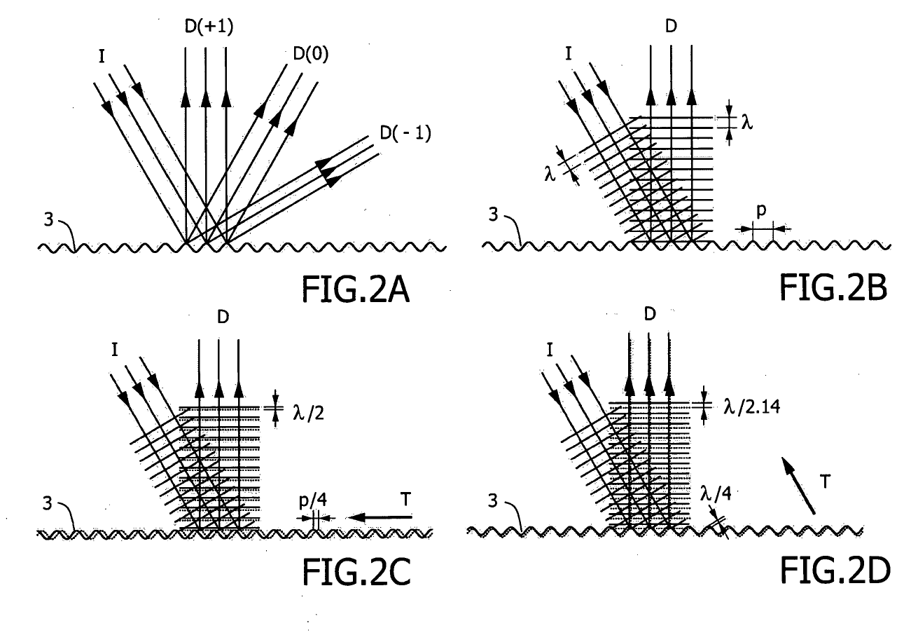

FIGS. 2A-2D show schematic illustrations of the effect of translations of a diffraction pattern on diffracted beams;

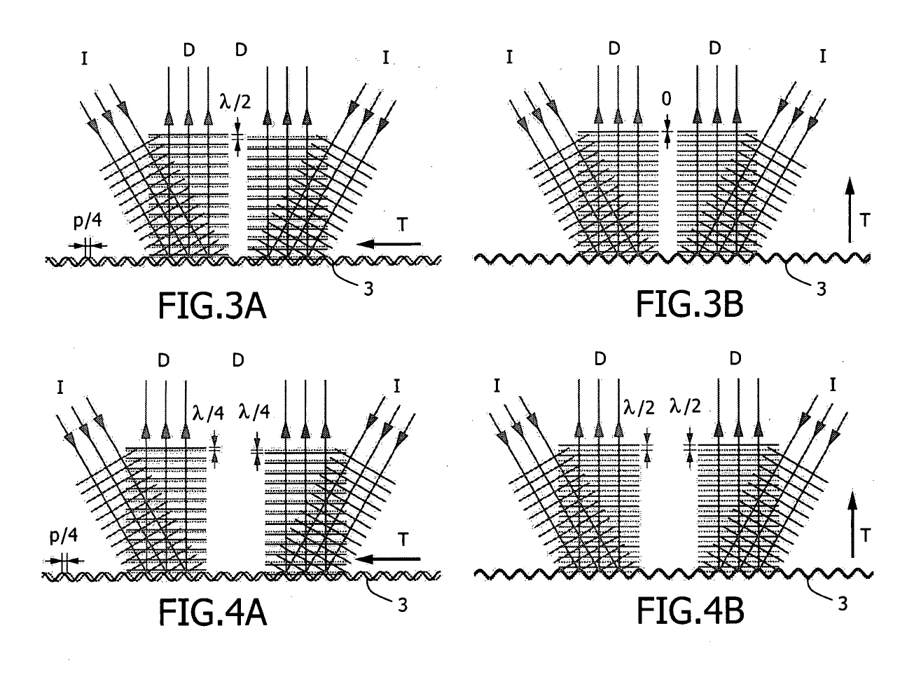

FIGS. 3A and 3B indicate the method of measuring phase differences according to the prior art;

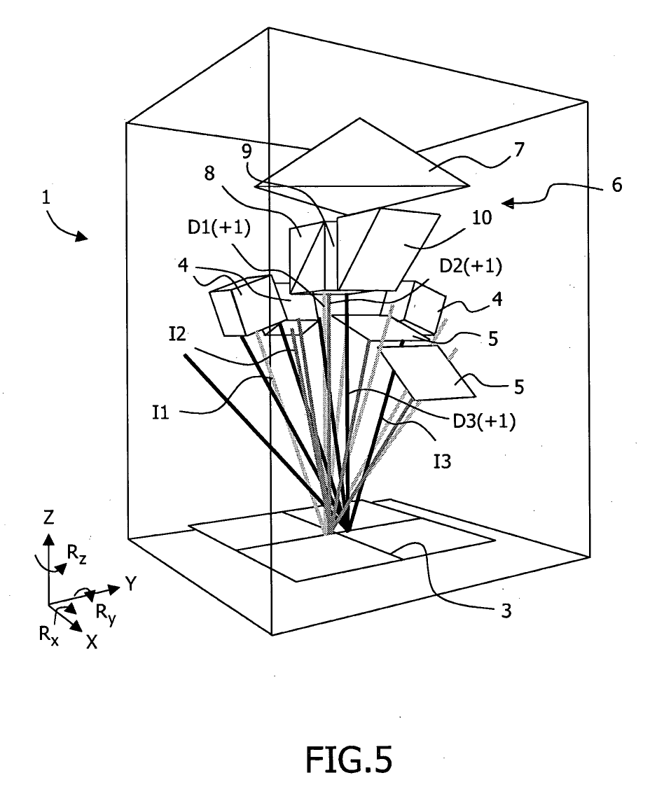

FIGS. 4A and 4B indicate the method of measuring phase differences according to an embodiment of the invention;

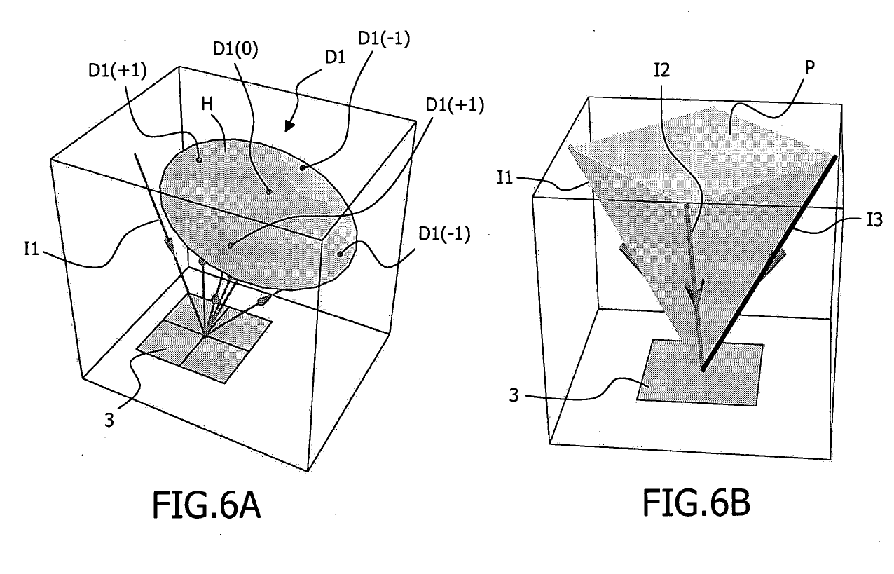

FIG. 5 schematically shows a system for detecting translations and rotation of a body according to an embodiment of the invention;

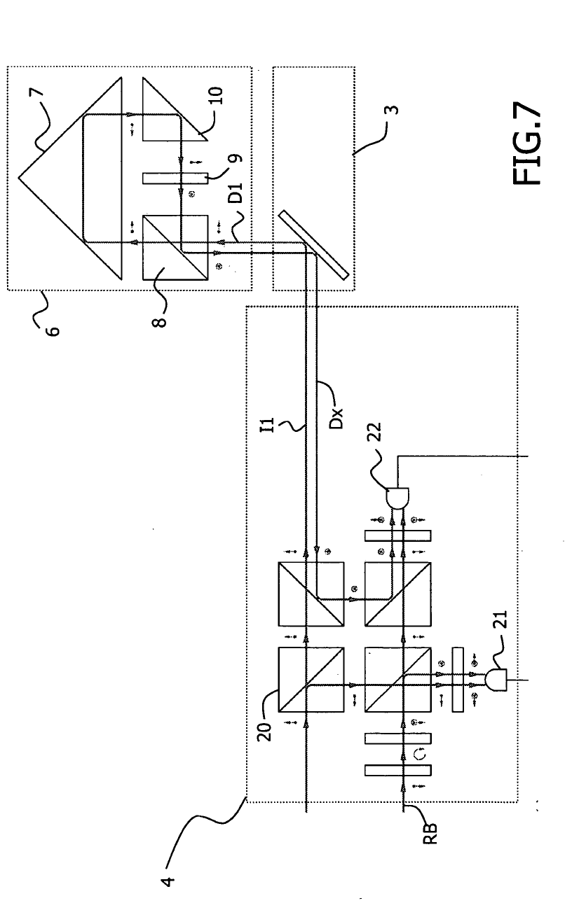

FIGS. 6A and 6B illustrate particular aspects of the system shown in FIG. 5;

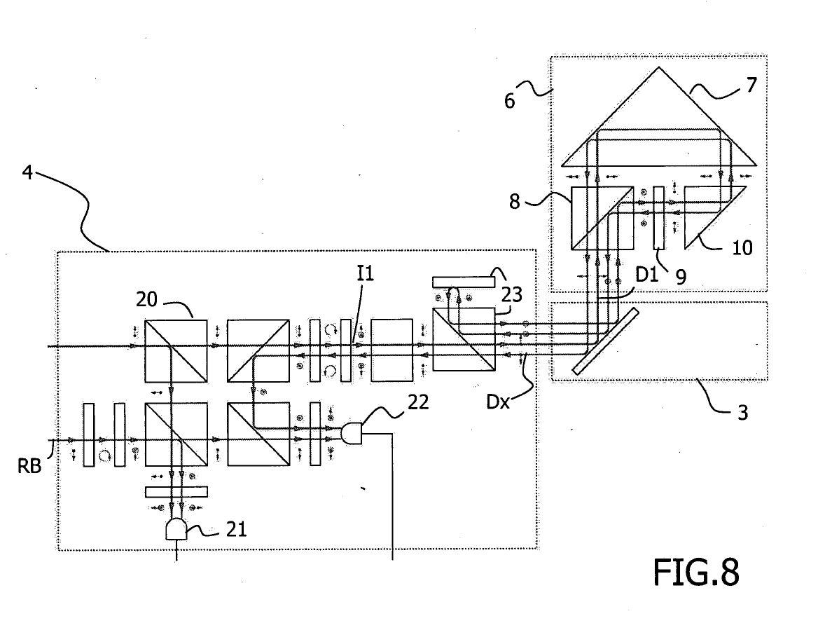

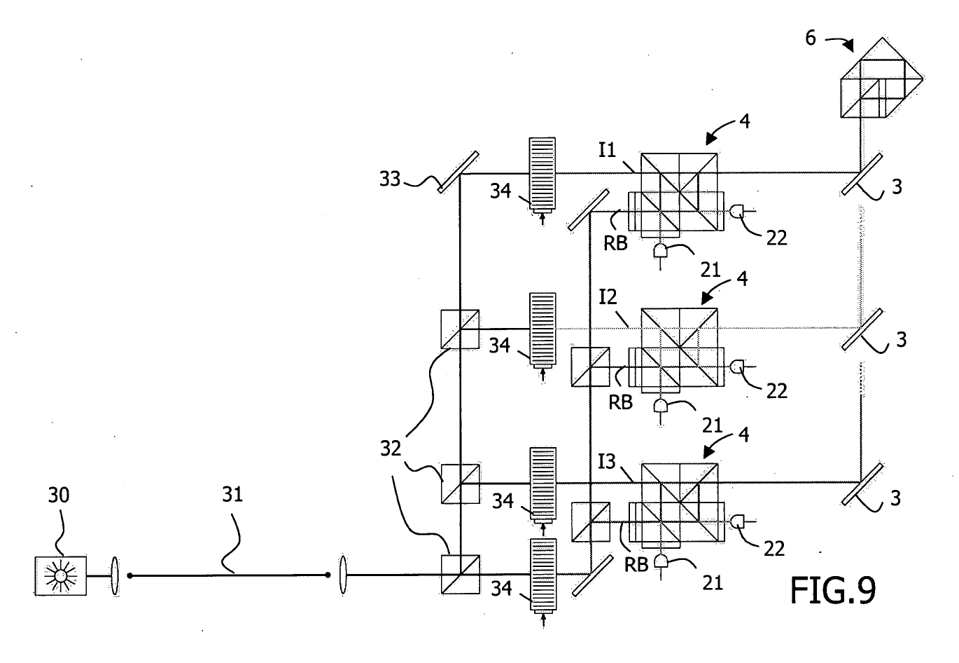

FIGS. 7 and 8 show two embodiments for the system for detecting translation of the body according to the invention;

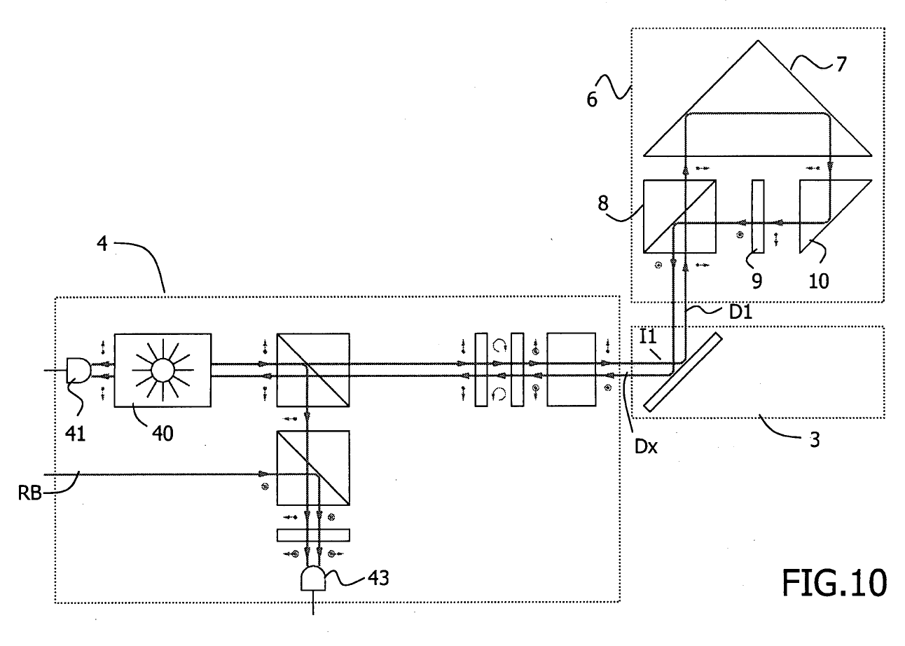

FIG. 9 shows a frequency multiplexer system for the system of FIGS. 7 and 8 according to an embodiment of the invention;

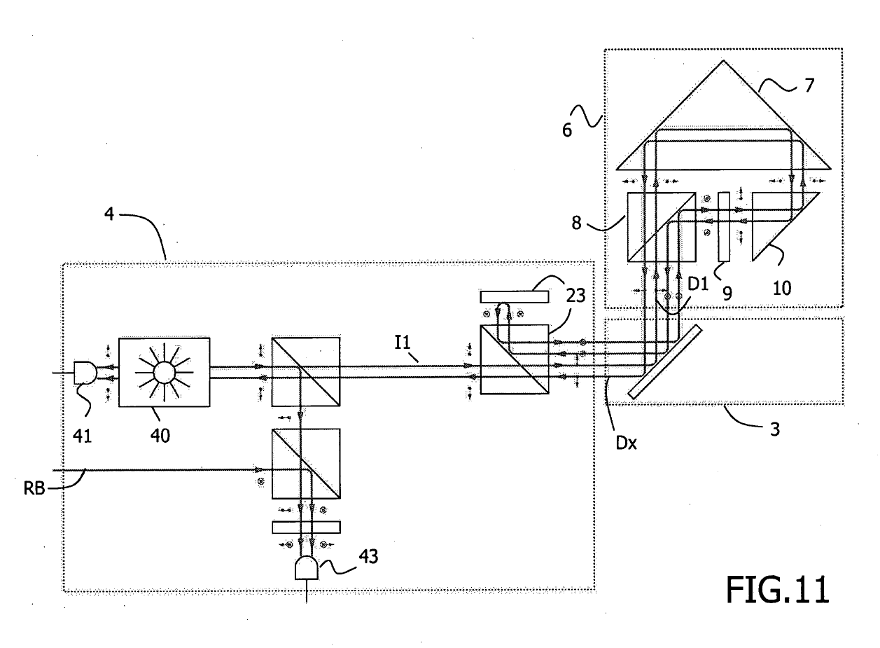

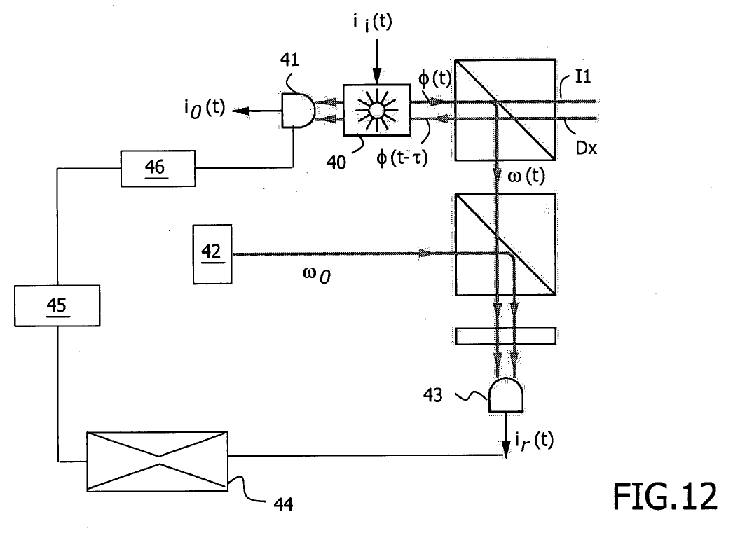

FIGS. 10 and 11 show two further embodiments for the system for detecting translation of the body according to the invention;

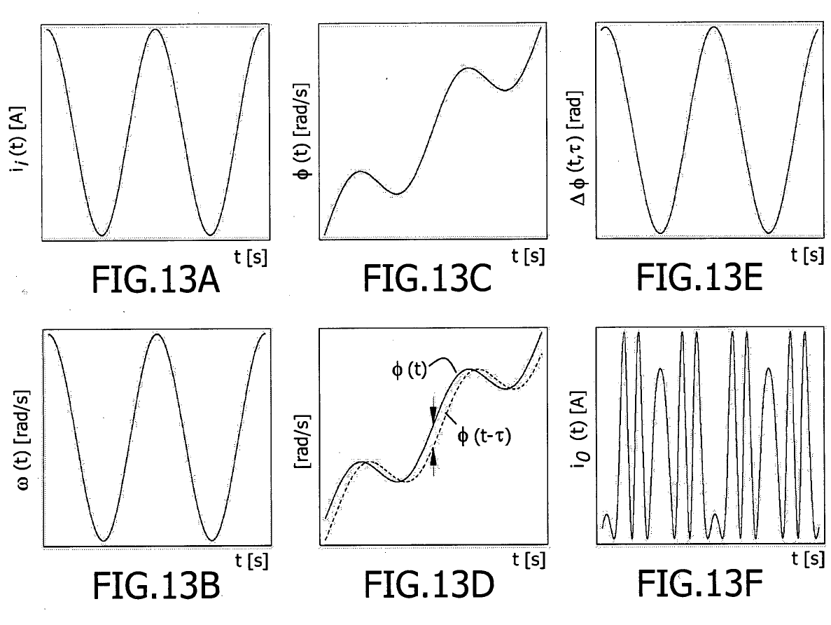

FIG. 12 shows a part of the embodiments of FIGS. 10 and 11 for measuring the phase difference between an incident beam and a reflected beam;

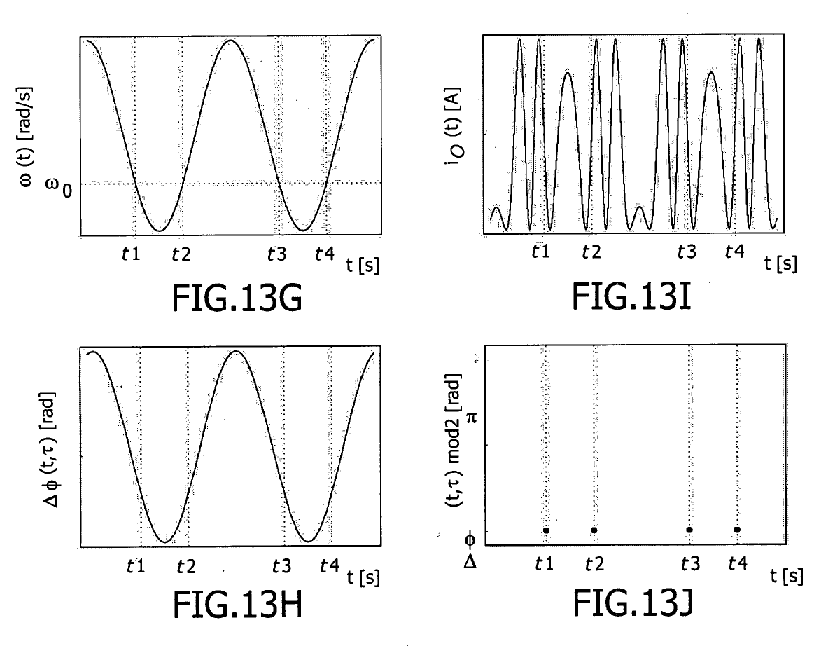

FIGS. 13A-13J show characteristic explaining the method applied in the embodiments of FIGS. 10-12;

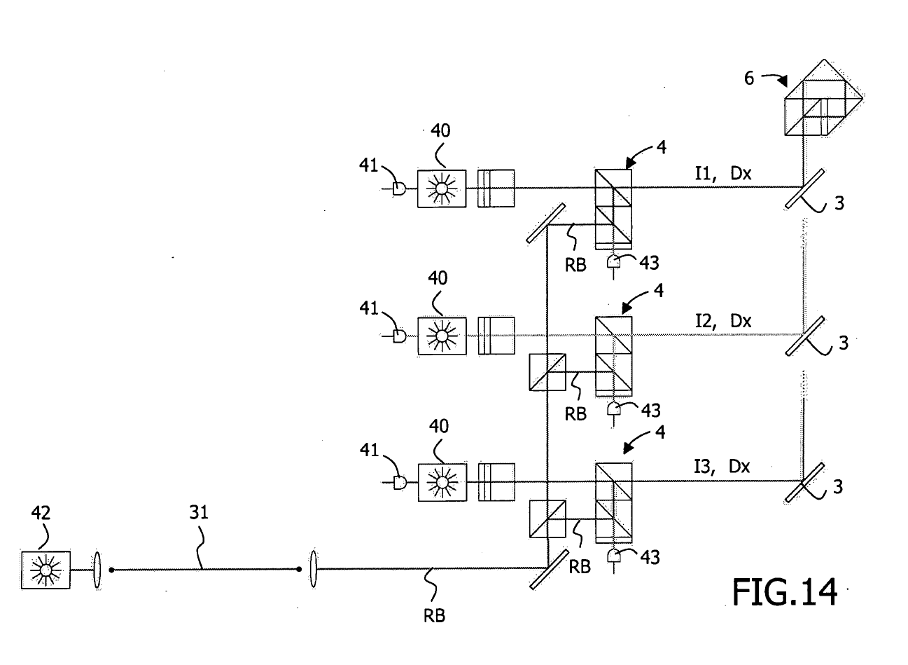

FIG. 14 shows integration of the embodiments of FIG. 10 or 11 in the system of FIG. 5, and

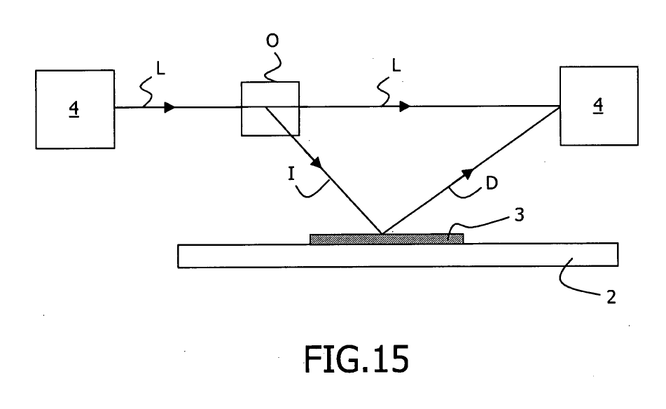

FIG. 15 shows a schematic illustration of the gist of the invention.

FIG. 1 schematically depicts a system 1 for detecting a translation of a body 2 with a diffraction pattern 3, hereinafter also referred to as grating 3, applied to said body 2. The body is e.g. a wafer or a printed circuit board. The diffraction pattern 3 may be directly applied to said body 2 or attached to said body 2 by means of one or more intermediate or auxiliary components (not shown). A measurement head 4 is provided at a stand-off distance S to detect translations of the body 2 in the X, Y and Z-direction as indicated.

FIGS. 2A-2D show schematic illustrations of the effect of translations of the periodic reflection grating 3. In FIG. 2A, an incident beam I is directed to the grating 3. The incident light beam I is diffracted from the grating 3, that is in rest, to form a diffracted beam D. The diffraction orders D(−1), D(0) and D(+1) of the diffracted light beam D are shown. FIG. 2B shows the same situation for the first order with indications of the wavelength λ of the incident light beam I and the diffracted light beam D.

FIGS. 2C and 2D respectively show the effect, indicated by the dotted lines for the situation before and the solid lines for the situation after the translation, of a translation of the grating 3 parallel to the plane of the grating 3 and with a component parallel to the normal \check{n} of the plane comprising the grating 3. As indicated, a translation of the grating 3 affects the phase of the diffracted beam D. In particular, an in-plane translation T for the grating 3 over a distance p/4 with p the period of the grating 3, results in a phase shift of λ/2. An out-of-plane translation over a distance λ/4 results in a phase shift of λ/2.14. In the description below, the situation of FIG. 2D will be approximated in that a translation parallel to the normal n over a distance λ/4 results in a phase shift of λ/2 for the diffracted beam D.

FIGS. 3A and 3B illustrate the conventional method of measuring phase differences ΔΦ. Two incident light beams I are provided at the grating 3 from different directions and the phase difference between the resulting diffracted light beams D is measured. For the in-plane translation T, depicted in FIG. 3A, the phase difference between the diffracted light beams D resulting from a translation T of p/4 is λ/2. However, an out-of-plane translation of the grating 3 is not measured as the phase shifts of the diffracted beams D balance each other.

FIGS. 4A and 4B indicate the system and method for measuring phase differences ΔΦ according to an embodiment of the invention. In contrast with the conventional method depicted in FIG. 3, the phase of each diffracted beam D is measured individually by measuring interference between an incident beam I and a diffracted beam D. Accordingly, a phase shift of λ/4 is measured for each pair of incident and diffracted beams for in-plane translation and a phase shift of λ/2 is measured for each pair for out-of-plane translations. Thus, the system and method according to the invention allows detection of in-plane and out-of-plane translations. To determine both the in-plane and out-of-plane translation, the system should be arranged such that it can distinguish phase shift contributions of the in-plane and out-of-plane translations. The in-plane translations can be determined optically or otherwise.

As an example, FIGS. 5, 6A and 6B schematically show a system 1 for detecting translations T and rotation R of the body 2 (not shown) with a two-dimensional grating 3 applied to the body. The system 1 comprises optical heads 4 for providing first, second and third incident light beams I1, I2 and I3 from different directions to the two-dimensional grating 3. First, second and third diffracted light beams D1, D2 and D3 result for these incident light beams I1, I2 and I3. Of the diffracted beams D1, D2 and D3 the diffraction orders −1, 0 and +1 are shown. Pairs of incident I and diffracted beams D are indicated in black, dark-gray and light-gray. To be able to discern the various beam paths, the beams in FIG. 5 do not coincide at the same measurement spot, but at three different spots with a small offset between them. In reality however, the three beams will coincide at the same measurement spot. The measurement heads 4 further comprise means for measuring the phase difference ΔΦ between at least one of the pairs consisting of said first incident beam I1 and said first diffracted beam D1, said second incident beam I2 and said second diffracted beam D2 and said third incident beam I3 and said third diffracted beam D3. As long as the optical power of the diffraction orders is sufficient, every diffraction order of the diffracted beams D1, D2 and D3 can be used for measuring the phase difference ΔΦ. The wavelengths and angles of incidence of the beams I1, I2 and I3 and the period p of the grating 3 have been determined such that the diffraction order +1 of the diffracted beams D1, D2 and D3 are used for detecting the translation T of the grating 3 with the measurement heads 4.

The system 1 further comprises position sensitive detectors 5 arranged to receive further orders, in FIG. 1 the order 0 and −1, of said diffracted light beams D1, D2 and D3 to detect rotation R of said body 2. A rotation Rₓ, R_{y}, R_{z} of the grating 3 results in a displacement of these orders on the position sensitive detectors 5 and accordingly, rotation of the body 2 can be detected. If the body 2 rotates, this may also influence the phases of the diffracted beams D1, D2 and D3 for measuring translation of the body 2 as the path length for one or more light beams may vary. Therefore, for a body 2 with a significant rotating motion component Rₓ, R_{y}, R_{z}, this rotation should be determined to calculate the translation of the body.

More precisely, for a two-dimensional diffraction grating 3, diffraction orders are indicated by two coordinates. The first order is indicated by (0,0), the first order in the x-direction by (1,0), the first order in the y-direction by (0,1) etc. In the embodiment described here, the further orders (0,0) and (−1,0) are used for measuring the rotation of the body 2. The order (0,0), hereinafter indicated again by order 0, is only sensitive to rotations Rₓ and R_{y}, while higher orders, here (−1,0) are sensitive to Rₓ, R_{y} and R_{z}. However, other further orders, such as (−1,−1), may be used as well. The indication hereinafter of the order by two coordinates is omitted for clarity purposes.

The diffracted +1st order beams D1, D2, D3 are directed to first redirection means 6. After passing this retro-reflector, the beams D1, D2, and D3 are directed to the grating 3 for a second time. Some of the diffracted beams are incident on the optical heads 4 and the phase of these further diffracted beams is measured for detecting a translation of the grating 3.

The diffracted orders 0 and −1 fall onto the two-dimensional position sensitive detector 5 and a one-dimensional position sensitive device, respectively. The position of the spot of diffraction order 0 is measured in two directions with the two-dimensional position sensitive detector 5, whereas the position of the −1st order beam is measured in one direction.

The three phase measurements and the three spot position measurements are used to determine the three translations and three rotations of the diffraction grating 3.

In FIG. 6A, for clarity reasons, only a single incident beam I1 is depicted with its associated diffraction beam D1 of which the orders +1, 0 and −1 are shown. Clearly, the grating period p, the wavelength λ, and the angle of incidence are chosen such that the diffracted +1st order beam in the plane of incidence is directed along the normal \check{n} of the grating 3. The spherical surface H in FIG. 6A is drawn only to show the orientation of the diffraction orders more clearly. The cross-lines in the grating 3 show the orientation of the two-dimensional diffraction grating.

The three optical heads 4 are positioned and oriented such that the three incident light beams I1, I2 and I3 are directed along three edges of a virtual pyramid P, shown in FIG. 6B. As can be seen in FIG. 5, the diffracted +1st order beams D1(+1), D2(+1) and D3(+1) in the plane of incidence of the three incident beams are parallel to each other and directed to the first redirecting means 6. This is typical for the beam layout in which the incident beams are directed along the edges of a virtual pyramid P.

The function of the first redirecting means 6, hereinafter also referred to as zero-offset retro-reflector, is to redirect an incoming beam such that the reflected beam is parallel to the incoming beam and also coincides with the incoming beam. The zero-offset retro-reflector 6 comprises a cube corner 7, a polarizing beam splitter cube 8, a half wavelength plate 9, and a prism 10 acting as folding mirror. Normally, cube corners are used as retro-reflectors. The incident and reflected beams are parallel to each other, but they are spatially separated. The zero-offset retro-reflector 6 redirects an incident beam along the same optical path back to the grating 3. If the direction or the position of the incident beam is not nominal, then the offset between the incident and reflected beams will not be zero.

The configuration of the optical heads 4 depends on the method with which the phase of the diffracted beams D1, D2, D3 is measured. For the measurement system based on two beam interference, the optical heads 4 can be configured as in FIGS. 7 and 8. It should be noted that in FIGS. 7 and 8 only the diffracted +1st order beam D1 is shown and not the 0th and −1st order beams. The symbols next to the beams indicate the polarization state. The offsets between the beams and the ‘curved’ reflections are used to clarify the beam paths. In reality, all parallel beams coincide. The configurations comprise several optical components, such as wavelength plates for modifying the polarization of the incident light beam, optical splitters and Faraday components, that are known in the art and are considered to need no further description here.

FIG. 7 shows a double-pass layout, in which the incident beam I1 is diffracted twice by the diffraction grating 3.

A reference beam RB is provided to measure the phase of the incident beam I interferometrically, i.e. by two-beam interference. Before the incident beam I1 is directed to the diffraction grating 3, a small part of it is split off by an optical component 20 and combined with a part of the reference beam RB and made to interfere at a detector 21. As is typical for a heterodyne system, the electrical signal from this detector 21 is used as a reference signal. The phase of this electrical reference signal is equal to the phase difference between the two interfering beams I1 and RB, apart from a certain constant. The part of the further diffracted beam Dx from the grating 3 to the optical head 4 is made to interfere at a second detector 22 with the remainder of the reference beam RB. The phase of the electrical signal from this detector 22 is equal to the phase difference between the two interfering beams Dx and RB, apart from a certain constant. The detector 22 converts intensity variations due to interference of light beam into electrical signals. Thus, the phase difference ΔΦ between the two detector signals is equal to the phase shift of the diffracted beam Dx, introduced by a translation T of the grating 3.

The double-pass beam layout of FIG. 7 ensures that the direction of the further diffracted beam Dx which interferes with the reference beam RB is independent of the rotation of the grating 3. A rotation of the grating 3 only leads to a displacement of that beam section, also referred to as ‘beam walk off’. As a consequence, the rotation range of the grating 3 is quite large, in comparison with a beam layout without the zero offset retro-reflector 6. With a beam diameter of 4 mm, and a stand-off distance S of 100 mm for the optical head 4, the rotation range will be about ±5 mrad.

To increase the rotation range further, a quad-pass layout can be used as illustrated in FIG. 8. With this beam layout, the incident beam I1 is diffracted four times by the grating 3 before it interferes with the reference beam RB. The diffracted beam returning to the optical head 4 is returned to the diffraction grating 3 once more by second redirecting means 23. The second redirection means 23 comprise a mirror and a polarizing beam splitter cube. The polarization is such that the light beam is fully reflected by the beam splitter cube. This quadpass beam layout not only compensates the beam deflection due to a rotation of the grating 3, but it also compensates the beam walk-off indicated above. In this case, the rotation range is limited by the size of the zero-offset retroreflector 6. With an aperture of 25 mm and a stand-off distance S of 100 mm for the optical head 4, the rotation range is ±60 mrad.

The rotation ranges mentioned above are based on the assumption that the body 2 is flat over the area on which the spots fall. This area is equal to the spot size plus the allowed beam walk-off. For the double-pass layout, the area has a diameter of 6 mm; for the quad-pass layout this area has a diameter of 25 mm. A curvature of the grating 3 over this area may reduce the rotation range. The rotation ranges wherein accurate detection of the translation of the body 2 is enabled may be considerably larger than for the prior art systems.

FIG. 9 shows the source system for the optical heads 4 in more detail. The system is based on a single, stabilized laser 30. The light from the laser, which for example has a wavelength of 632.8 nm, can be directed to the optical heads 4 directly via air or via a glass fiber 31 as shown in FIG. 9. The fiber option can be useful if the laser 30 has to be placed outside a vacuum chamber. The laser light is split into four parts by splitters 32 and a mirror 33 and each part is shifted in frequency by an acousto-optical modulator 34. One of these four beams is used as the reference beam RB. The other beams are the incident beams I1, I2 and I3 for the grating 3.

The four frequencies at which the acousto-optical modulators 34 are driven are chosen such that the frequencies of the electrical signals for the detectors 21 and 22 (the so-called beat frequencies which are equal to the frequency differences between further diffracted beams Dx and reference beams RB) are different from each other. As a result, the detector signal frequencies are in separate bands. It is noted that accordingly, due to motion of the grating 3, the frequencies of the further diffracted beams Dx change, and as a consequence, the beat frequencies shift.

The reason for choosing these beat frequencies to be in separate frequency bands is the following. As shown in FIG. 5, the zero order beam of D1 is parallel to the first order beam of D3 reflected by the zero-offset retro-reflector 6 and both fall onto the optical head 4 for D3. Similarly, the zero order beam of D3 is parallel to the retro-reflected first order beam for D1 and both fall onto the optical head 4 for D1. The unwanted zero order beam at the optical heads 4 will interfere with the reference beam RB as well as with the first order beams D1,D2, D3. By choosing different beat frequencies, all the interference contributions are frequency multiplexed. As a consequence, the wanted and unwanted contributions can be separated by filtering.

As an example, the frequencies of the acousto-optical modulators are chosen to be 15 MHz, 30 MHz, 45 MHz and 60 MHz. Thus, the frequencies of the detector signals will be (if the grating is not moving) 45 MHz, 30 MHz, and 15 MHz for the first, second and third incident beams I1, I2 and I3 respectively. If each of these signals varies within a bandwidth of ±7.5 MHz due to the motion of the grating 3, then the variation is still in separate bands. For an angle of incidence of 20° for I1, I2 and I3 and a wavelength λ of 632.8 nm, the grating period p has to be 1.85 μm. With these values and with the quad-pass beam layout of FIG. 8, an in-plane grating translation T at 3.5 m/s will lead to a frequency shift of 7.5 MHz. With the double-pass beam layout of FIG. 7, a speed of 7 m/s will lead to a frequency shift of 7.5 MHz.

The unwanted contributions to the interference in the optical head 4 meant for the diffracted beam D1 are due to interference between the zero order beam D3 and the reference beam RB at a beat frequency of 15 MHz and interference between the zero order beam D3 and the diffracted beam D1 at a beat frequency of 30 MHz. The wanted contribution is due to interference between the diffracted beam D1 and the reference beam RB at a beat frequency of 45 MHz. Summarizing, by selective filtering, the wanted and unwanted contributions can be separated.

FIGS. 10-14 illustrate an alternative system for phase measuring based on laser self-mixing. Just like with the previous embodiment shown in FIGS. 7-9, a double-pass beam layout and a quad-pass layout are shown in FIGS. 10 and 11. Reference numbers identical to the numbers of FIGS. 7 and 8 indicate identical or similar components; further components, such as wavelength plates for modifying the polarization of the incident light beam and optical splitters, are also present.

The incident light beam I1 is generated by the diode laser 40. The diffracted light beam Dx that is returned to the laser 40 influences the laser power, which is monitored by the detector 41 by leakage of a small portion of the incident light to this detector, such that the phase shift of the detector signal i₀(t) is equal to the phase shift ΔΦ of the returned diffracted beam Dx. Thus, by measuring the phase shift of the detector signal i₀(t), the phase shift of the diffracted beam Dx, which results from a translation T and/or rotation R of the grating 3 can be determined. Further, a stabilized laser 42 provides a reference beam RB.

The system of FIGS. 10-14 is inherently homodyne and cannot be converted into a heterodyne system by introducing a beat frequency as previously described with reference to FIGS. 7-9. The problem is therefore how to measure the phase shift of the diffracted beam Dx from a light intensity variation at the detector 41.

FIGS. 12 and 13A-13J illustrate an embodiment of the invention for solving this problem. The diode laser 40 is modulated using the input current iᵢ(t). The output current of the detector or monitor diode 41 is denoted by iₒ(t). The phase of the incident light beam is φ(t). The phase of the diffracted light beam is indicated with φ(t−τ), with τ the time it takes for the laser beam to return to the laser 40. The radial frequency of the laser beam is ω(t). The radial frequency of the reference beam RB is denoted with ω₀.

The modulation of the diode laser is shown in FIG. 13A. The input current iᵢ(t) is modulated with a frequency of 2 MHz, which provides four samples per period for a speed of 1 m/s of the grating 3 with a period p of 1.85 μm for the quadpass beam layout of FIG. 11. A minimum number of samples per period is required to determine which sample corresponds to which period. It has been established that four or more samples is a practical number. FIG. 13B shows the resulting modulation of the frequency ω(t) of the incident laser beam I1. FIG. 13C shows the resulting modulation of the phase φ(t) of the incident laser beam I1. FIG. 13D shows the phase φ(t) and the delayed phase φ(t−τ) of the returned beam Dx. The phase difference, denoted as Δφ(t, τ), is shown in FIG. 13E. This phase difference is equal to the phase of the output current iₒ(t). That output current is shown in FIG. 13F.

In order to measure the phase shift introduced by a translation T of the grating 3, the phase of iₒ(t). However, due to the modulation of the frequency (or wavelength), the relation between phase shift and translation is unknown. Therefore, the wavelength λ should be determined and taken into account. The wavelength of the diode laser 40 is not very stable, due to drifts. As a consequence, it is advantageous to measure the wavelength of the diode laser 40 by a detector 43 generating a current iᵣ(t). The accuracy is determined mainly by the stand-off distance S and the required accuracy with which the translation T should be detected. At a stand-off distance S of 100 mm, a quad-pass beam setup of FIG. 11 and a required translation accuracy of 1 nm, the wavelength accuracy should be about 10⁻⁹.

Such accuracies can be reached by directly measuring the frequency difference between the diode laser 40 and the stabilized reference laser 42. Because of the high modulation frequency of the input current iᵢ(t), the frequency difference is not measured continuously. Instead, the system is arranged to generate a trigger if the wavelength ω(t) of the diode laser 40 crosses a certain value, determined by the wavelength ω₀ of the reference laser 42 and the central frequency of a narrow-bandpass filter 44 connected to the detector 43. An electrical power detector 45 is used to detect the passed signal. FIGS. 13G-13J shows the trigger signal from a trigger unit 46 and its relation to the phase measurement of i₀(t). The phase difference between the incident laser beam I1 and the diffracted laser beam Dx is measured at times t1, t2, t3 and t4, i.e. when ω(t)≈ω₀.

The trigger is generated from the trigger unit 46 with an accuracy of 0.5 MHz to get the 1 nm accuracy. The modulation depth of the input current must be such that the phase shift is a few times 2π. Thus, with a center wavelength of about 0.6 μm for the laser, a stand-off distance S of 100 mm, the quad-pass beam layout of FIG. 11, the relative wavelength change is about 1.5×10⁻⁶. This corresponds to an absolute wavelength change of about 1 pm. Thus, the modulation depth of the frequency ω(t) is about 2π×750 MHz (the average value for the diode laser 40 is about 2π×500 THz).

FIG. 14 illustrates the integration of the diode lasers 40 in the system of FIG. 5. For the wavelength trigger, a stabilized laser 42 common for all optical heads 4 is applied. As the diode lasers 40 of the three optical heads are not correlated for the three measurement direction, the problem of cross-talk as encountered for the heterodyne system of FIGS. 7-9, is circumvented.

A particularly interesting application of the system according to the invention is for wafer positioning. Conventionally, wafer positioning is performed by placing a wafer on a chuck that has attached mirrors. With the system of the invention, such a chuck may be omitted and positioning of the wafer can be controlled by applying a diffraction grating 3 on the wafer and measuring phase difference between an incident beam on said wafer and a diffracted beam from said wafer.

It should be noted that the above-mentioned embodiments illustrate, rather than limit, the invention, and that those skilled in the art will be able to design many alternative embodiments without departing from the scope of the appended claims. The gist of the invention relates to the insight that measuring the phase difference between a beam D which is diffracted by a grating 3 and a light beam L which is not, allows to detect in-plane as well as the out-of-plane translation of the grating 3, as shown in FIG. 15. An optical element O directs a portion I of the light beam L to the grating 3 to obtain the diffracted beam D whereas another portion of the light beam L is transmitted towards a measurement head 4. The measurement head 4 measures the phase difference between the diffracted beam D and the non-diffracted light beam D.

In the claims, any reference signs placed between parentheses shall not be construed as limiting the claim. The word “comprising” does not exclude the presence of elements or steps other than those listed in a claim. The word “a” or “an” preceding an element does not exclude the presence of a plurality of such elements. The mere fact that certain measures are recited in mutually different dependent claims does not indicate that a combination of these measures cannot be used to advantage.

1. A system (1) for detecting a translation (T) of a body (2) with a diffraction pattern (3), said system comprising:
means (4) for providing an incident light beam (I) to said diffraction pattern and to obtain a diffracted light beam (D) from said diffraction pattern;
means (4) for measuring a phase difference by interference between said incident light beam and said diffracted beam;
means (4) for detecting said translation on the basis of said measured phase difference.

2. The system (1) according to claim 1, wherein said means for detecting said translation are arranged to detect a translation of said body parallel to the normal of a plane with a diffraction grating.

3. The system (1) according to claim 1, wherein said diffraction pattern is a two-dimensional diffraction pattern (3) and said system comprises:
means (4) for providing a first, second and third incident light beam (I1,I2,I3) to said diffraction pattern from a first, second and third direction to obtain a first, second and third diffracted beam (D1,D2,D3),
means for measuring a phase difference between at least one of the pairs (I1,D1;I2,D2;I3,D3) consisting of said first incident beam and said first diffracted beam, said second incident beam and said second diffracted beam and said third incident beam and said third diffracted beam.

4. The system (1) according to claim 3, wherein said system for comprises position sensitive detectors (5) arranged to receive further orders (0, −1) of said diffracted light beams (D1,D2,D3) to detect rotation of said body.

5. The system (1) according to claim 3, wherein said system further comprises one or more redirection means (6;23) for redirecting said first, second and third diffracted beams (D1,D2,D3) one or more times towards said diffraction pattern of said body to obtain further diffracted light beams (Dx).

6. The system (1) according to claim 5, wherein one of said redirection means (6) includes a cube corner (7), a polarizing beam splitter (8), a half wavelength plate (9) and a prism (10) arranged to redirect said first, second and third diffracted beams (D1,D2,D3) towards said diffraction pattern substantially along the same optical path.

7. The system according to claim 5, wherein said means for measuring a phase difference comprises an input for a reference beam (RB) and a first detector (21) to measure a phase difference between an incident light beam (I1,I2,I3) and said reference beam (RB) and a second detector (22) to measure a phase difference between said reference beam (RB) and a further diffracted light beam (Dx).

8. The system according to claim 3, wherein said system is arranged to have different frequencies for said first, second and third incident light beam (I1,I2,I3).

9. The system according to claim 8, wherein said system comprises a single laser source (30) to provide a laser beam of a predetermined frequency and means (32,33) for splitting said laser beam into four parts and shifting the frequency of three parts to obtain said different frequencies for said incident light beams (I1,I2,I3), wherein said system is arranged to use the fourth part as a reference beam (RB) in combination with each of said three parts for said means (4) for measuring a phase difference.

10. The system (1) according to claim 3, wherein said system comprises a semiconductor laser (40) arranged to provide at least one of said first, second or third incident light beams (I1,I2,I3) and to receive said first, second or third diffracted light beam (D1, D2, D3) or a further diffracted beam (Dx) and to output a portion of said incident light beam (I1,I2,I3) and said diffracted light beam (D1,D2,D3;Dx) to said means for measuring a phase difference.

11. The system (1) according to claim 10, wherein said semiconductor laser (40) is further arranged to receive a modulation signal (iᵢ(t)) for varying the frequency of said incident light beams (I1,I2,I3).

12. The system (1) according to claim 10, wherein said system further comprises a stabilized laser (42) to provide a reference beam (RB) with a stabilized frequency (ω₀) and a further detector (43) for detecting the frequency (ω(t)) of said incident beam (I1) and said reference beam (RB).

13. The system (1) according to claim 12, wherein said system is arranged to trigger said means (4) for measuring said phase difference when said stabilized frequency (4) substantially matches said frequency (ω(t)) of said incident beam (I).

14. A method for detecting a translation (T) of a body (2) with a diffraction pattern (3) applied to said body, comprising the steps of:
providing an incident light beam (I) to said diffraction pattern;
obtaining a diffracted light beam (D) from said diffraction pattern;
measuring a phase difference by interfering said incident light beam (I) and said diffracted beam (D);
detecting said translation on the basis of said measured phase difference.

15. The method according to claim 14, wherein said method comprises the steps of:
providing a first, second and third incident light beam (I1,I2,I3) to said diffraction pattern (3) from a first, second and third direction to obtain a first, second and third diffracted beam (D1,D2,D3), and measuring a phase difference between at least one of the pairs (I1,D1; I2,D2; I3,D3) consisting of said first incident beam and said first diffracted beam, said second incident beam and said second diffracted beam and said third incident beam and said third diffracted beam.

16. The method according to claim 15, wherein said method further comprises the step of detecting rotation (Rₓ;R_{y};R_{z}) of said body by receiving further orders (0,−1) of said diffracted beams at position sensitive detectors (5).

17. A redirection arrangement (6) for returning a light beam (D1, D2, D3) incident on said arrangement substantially along the same optical path, said arrangement comprising a cube corner (7), a polarizing beam splitter (8), a half wavelength plate (9) and a prism (10).

18. The redirection arrangement (6) according to claim 17, wherein said polarizing beam splitter (8) has a face for receiving said incident light beam (D1, D2, D3) and said arrangement is constructed to pass said light beam (D1, D2, D3) respectively via said cube corner (7), said prism (10), said half wavelength plate (9) and again said polarizing beam splitter (8) such that said light beam leaves said face at substantially the same position as said incident light beam.

19. A frequency multiplexing system arranged to provide light beams (I1, I2, I3) to a body (2) with a diffraction pattern (3) in a system for detecting translation (T) of said body, wherein said frequency multiplexing system comprises a single laser source (30) to provide a laser beam of a predetermined frequency and means (32,33) for splitting said laser beam into a plurality of parts and shifting the frequency of one or more of said parts to obtain different frequencies for said incident light beams (I1, I2, I3), wherein said system is arranged to use one of said parts as a reference beam (RB) in combination with each of said incident beams for said system for detecting a translation of said body.

20. A system (1) for detecting a translation (T) of a body (2) with a diffraction pattern (3), said system comprising:
means (4) for providing a light beam (L);
means to obtain a diffracted light beam (D), coherent with said light beam (L), from said diffraction pattern;
means (4) for measuring a phase difference by interference between said light beam and said diffracted beam;
means (4) for detecting said translation on the basis of said measured phase difference.
